(19) United States
(12) Patent Application Publication
(10) Pub. No.: US 2010/0320133 A1
(43) Pub. Date: Dec. 23, 2010

(54) SAND SEPARATION VESSEL

(75) Inventors: Pat PAGE, Medicine Hat (CA); Jack MONKMAN, Medicine Hat (CA)

Correspondence Address: EDWARD YOO C/O BENNETT JONES, 3200 TELUS HOUSE, SOUTH TOWER, 10020 - 100 STREET, EDMONTON, ALBERTA, AB, T5J 0N3, CA

(73) Assignee: TARSANDS RECOVERY LTD., Medicine Hat (CA)

(21) Appl. No.: 12/792,377

(22) Filed: Jun. 2, 2010

(30) Foreign Application Priority Data
Jun. 19, 2009 (CA) 2669710

(51) Int. Cl. B03B 9/02; B08B 3/02; B09C 1/02; B01D 21/28; B01D 17/02

(52) U.S. Cl. 210/207

(57) ABSTRACT

A vessel for separating sand and other solid particulate matter from heavy oil and other hydrocarbons includes a horizontally disposed vessel having a plurality of internal weirs. There are gaps below the weirs along the bottom of the vessel where the vessel defines a plurality of longitudinal channels having a plurality jets. The wash jets provide fluid force to move the sand along the channels and provide agitation. The oily solids may be introduced into the vessel at a first end and collected from a solids outlet at a second end. Oil and wash fluid may be skimmed from upper portion of the vessel with an oil skimmer at the first end.

### FIELD OF THE INVENTION

The present invention relates to a vessel for separating particulate matter and hydrocarbons. In particular, the vessel may be used for separating sand mixed or coated with heavy oil or bitumen.

### BACKGROUND OF THE INVENTION

Heavy oil is often produced along with large amounts of sand and water. Primary separation of the oil, sand and water mixture takes place in field storage tanks, where the sand and other solid particulate matter sinks to the bottom, while the oil floats to the top. The oil is removed periodically while the sand and water are also periodically cleaned from the tank. As may be appreciated, there is usually a significant amount of oil contaminating the solids removed from storage tanks. This contamination complicates the disposal of such produced solids.

The separation and disposal of produced sand from heavy oil well production is a major production and environmental problem in the heavy oil producing areas, such as certain areas of Western Canada. Currently, the two most common means of handling produced sand involves the trucking and injection of produced solids into specialized disposal wells, or by landfarming the product. An alternative method for dealing with the produced sand involves using the product in road construction. However, there are environmental and regulatory issues involved with both landfarming and reuse in road construction.

Applicant's co-owned CA Patent Application No. 2,455,239 describes an oil separation vessel which employs internal baffles or weirs and wash jets to treat sand or other solids which are contaminated with oil.

However, there remains a need in the art for an economical and environmentally sound method of treating sand which is contaminated with oil, to recover the oil and sand as separate products.

### SUMMARY OF THE INVENTION

The present invention provides a separation vessel for treating sand and other particulate matter contaminated with heavy oil and other hydrocarbons. In one aspect, the invention may comprise a separation vessel comprising:
(a) an elongate vessel having a first end and a second end, a bottom portion, and a longitudinal axis passing through the first and second ends, the bottom portion defining a plurality of longitudinal channels;
(b) a plurality of internal weirs transversely disposed within the vessel and having a top edge and a bottom edge, wherein the bottom edge does not block the longitudinal channels;
(c) a plurality of jets disposed along each longitudinal channel and aimed substantially towards the second end of the vessel;
(d) a pump subsystem for pressurizing a wash fluid and directing the fluid through the jets into the vessel;
(e) a feedstock inlet associated with the first end of the vessel;
(f) a fluid outlet defined by the vessel, substantially level with or higher than the height of the top edge of an internal weir; and
(g) a solids outlet defined by the vessel towards the second end of the vessel.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a top plan view of one embodiment of the present invention.

FIG. 2 is a longitudinal cross-section view along line A-A in FIG. 1.

FIG. 3 is a cross-sectional view along line B-B in FIG. 1.

FIG. 4 is a cross-sectional view along line C-C in FIG. 1.

FIG. 5 is a cross-sectional view along line D-D in FIG. 1.

FIG. 6 is a cross-sectional view along line E-E in FIG. 1.

FIG. 7 is an end view of the second end of the vessel shown in FIG. 1.

### DETAILED DESCRIPTION OF THE INVENTION

The present invention provides for a separation vessel. When describing the present invention, all terms not defined herein have their common art-recognized meanings. The vessel is intended to receive sand, or other solid particulate material, which is contaminated with heavy oil, or other hydrocarbons. Through the use of a wash fluid which may comprise a solvent or surfactant, or combinations thereof, the oil is separated from the sand and removed. The sand is cleaned and recovered.

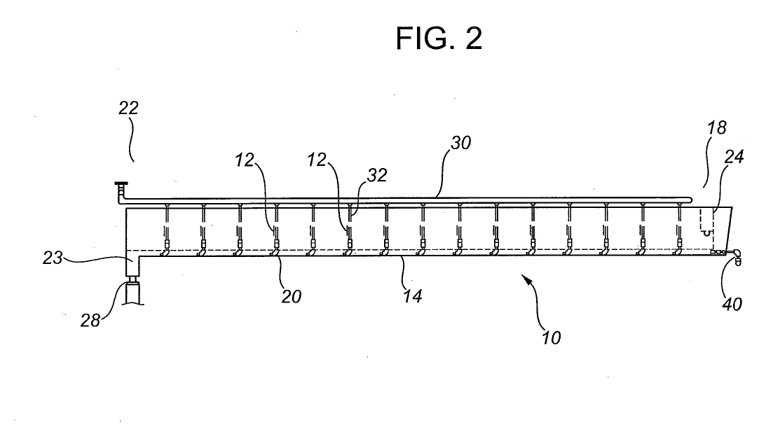

One embodiment of a vessel of the present invention is shown in the Figures. The vessel is an elongated vessel (10) which may be, but not necessarily, a box-like vessel. The interior of the vessel is divided by a plurality of transverse weirs (12) which are attached to the interior sidewall of the vessel (10) as shown in FIGS. 2 and 4. The weirs (12) have a defined height, which may be adjustable, and leave a gap between the bottom of the weir, and the bottom (14) of the vessel. The bottom gap may be adjustable.

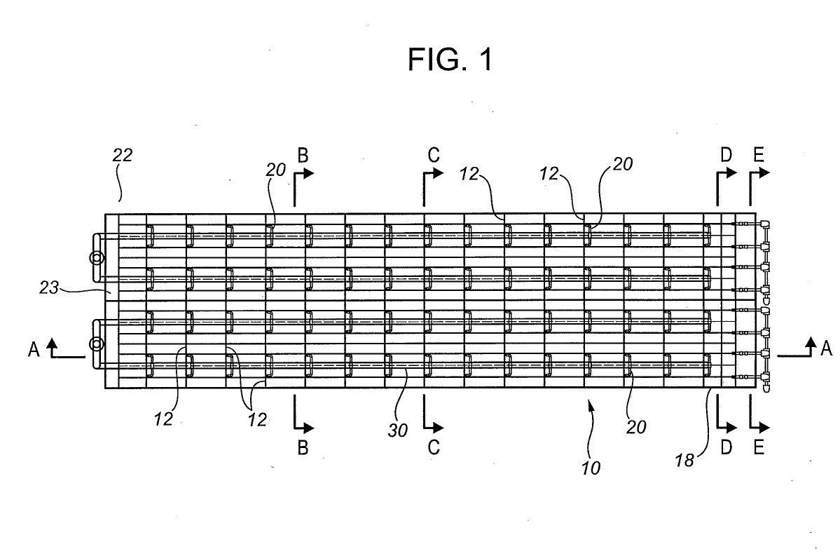

Contaminated sand is introduced into the vessel through a feedstock intake, which is provided at a first end (18) of the vessel. A plurality of wash jets (20) are provided along the bottom (14) of the vessel, below the bottom level of the weirs (12), as is shown in FIGS. 1 and 4. The wash jets (20) introduce a wash fluid into the vessel, agitate the sand which has settled to the bottom of the vessel, and push the sand towards the second end (22) of the vessel.

The vessel may be closed or it may have a top portion removed for easy physical and visual access to the vessel interior.

The feedstock intake may be a hopper or trough which delivers the contaminated sand to the vessel. The feedstock may preferably be an aqueous slurry of contaminated sand.

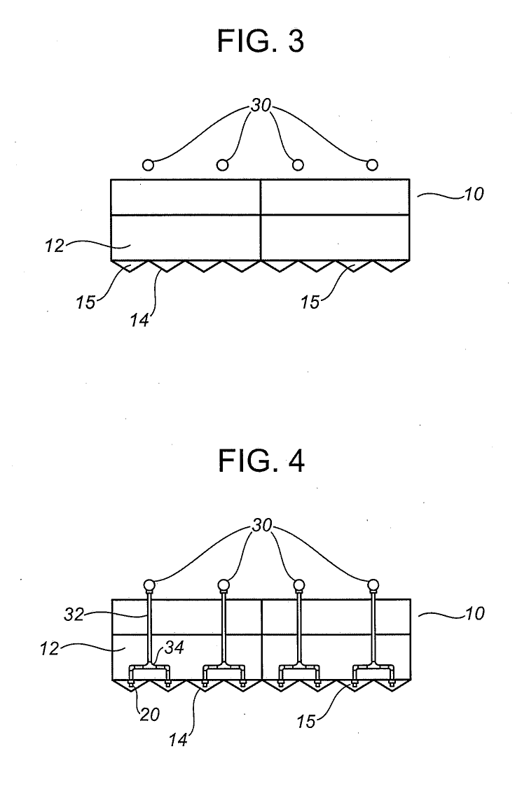

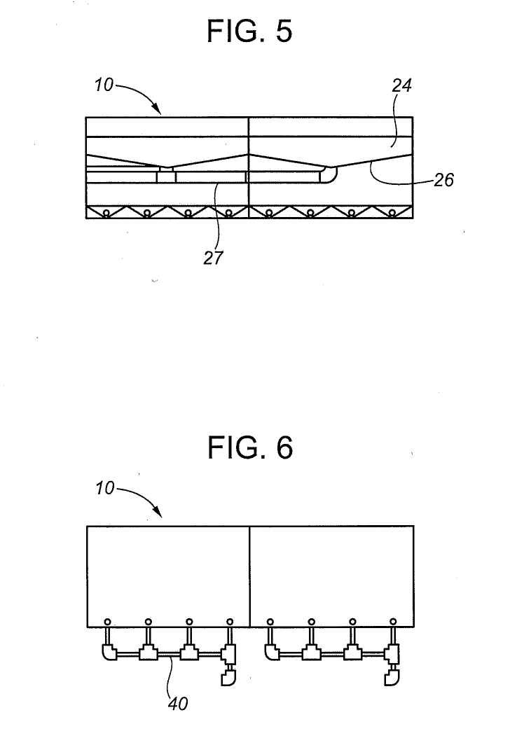

The bottom (14) of the vessel defines a plurality of longitudinal channels (15), formed by a waveform of the vessel bottom. In one embodiment, each channel is V-shaped, as is shown in FIGS. 3 and 4. In alternative embodiments, the channels may be formed by a sinusoidal or other repeated waveform. In one embodiment, each internal weir (12) may contact the top of the vessel bottom waveform, leaving the longitudinal channels open.

Also shown in FIG. 4, the wash jets (20) are arrayed in each channel (15) along the bottom portion of the vessel. In one embodiment, a number of jets are provided along a line which is transverse to the longitudinal axis of the vessel, with at least one wash jet in each channel. In one embodiment, the rows of wash jets may be substantially aligned with the internal weirs and therefore, there may be as many transverse rows of wash jets as there are internal weirs. Each traverse row may be positioned just behind a weir, such that the jets push solids from one compartment to the next.

In one embodiment, each wash jet is supplied through a pump system which is delivered to the jet by an overhead piping system. A fluid pump (now shown) delivers fluid to an overhead longitudinal pipe (30), which may supply one or more longitudinal rows of jets (20). In one embodiment, shown in FIG. 4, each overhead pipe (30) is connected to a downpipe (32), which leads to a “T” fitting (34), which feeds two jets (20) in adjacent channels (15). At the first end (18) of the vessel, the initial transverse row of jets is fed by a separate pipe (40) system passing through the vessel wall, because the overhead pipes (30) would interfere with the feedstock intake and oil skimmer at the first end (18).

Upon activation of the wash jets, some circulation will occur within each compartment created between two adjacent weirs (12). Accordingly, the length of the vessel and the number of weirs are important factors in determining the efficacy of the washing action. At a bare minimum, a single weir would create two compartments. The maximum number of weirs is limited only by the length of the vessel and complexity of fabrication. It is preferable to provide enough spacing between the weirs that adequate recirculation of the solids and wash fluids takes place.

Each wash jet (20) may be conveniently fabricated from conventional pipe fittings such as a standard 90° elbow fittings with a restricted nozzle outlet. The jet outlet may be restricted to increase the velocity of the fluid flowing from the wash jet, or expanded to increase fluid volume.

The wash fluid may be a surfactant or a solvent, or mixtures thereof, known to remove oil from sand. Preferably, the wash fluid is a surfactant mixed in water.

The action of the wash fluid jetted into the vessel (10) scrubs the sand and pushes the sand along the bottom of the vessel, along the longitudinal channels (15) towards the second end (22) of the vessel. Because of the turbulence created by the jets, some sand will also circulate within a cell between adjacent weirs, before passing on to the next section. The oil is liberated from the sand. If the vessel is of sufficient length, by the time the sand has reached the solids outlet (28), which is located at the second end (22), it is relatively free of oil. A portion of the oil may initially be emulsified in the wash fluid and may remain in emulsion before removal, or may coalesce, float to the top and be removed as an oil fraction. Provided that the fluid level in the vessel is high enough, the oil will float on the surface, above the level of the weirs. The weirs (12) act to substantially prevent recirculation of solids and fluids within the vessel from the second end (22) to the first (feed intake) end (18). When sufficient oil has been separated, it may be removed by skimming the oil with an oil skimmer or draw off (24). Preferably, the oil skimmer (24) is substantially level with or above the top of the weirs (12). In one embodiment, the oil skimmer (24) is a transverse basin (26) having a bottom discharge tube (27). Oil is skimmed into the basin (26) and is collected by the discharge tube (27) which runs transversely to the vessel (10). As shown in FIG. 2, the basin (26) extends only partly down into the vessel, and does not interfere with the action of the wash jets in the lower portion of the vessel. The oil skimmer (24) may remove wash fluid along with oil, therefore, oil/water separators may be provided to recover wash fluid, which may be reused.

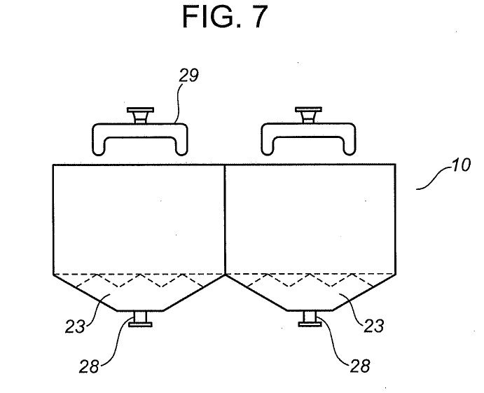

As shown in FIG. 7, clean sand may be removed from the vessel from the solids outlet (28) by conventional means. The longitudinal channels terminate in a solids collection chamber (23) which may be emptied with the solids outlet (28). The sand will be contained in a fluid slurry. The slurry may be transported to a hydrocyclone (not shown), or other separating device, to separate the liquids and the solids. The liquids may be returned to a wash fluid makeup tank where it may be reused by returning to the vessel through the wash jets.

In one embodiment, the oil skimmer (24) is located at the first end of the vessel. Therefore, there is some countercurrent flow in the vessel. Solids are primarily pushed from the first end (18) to the second end (22), and discharged from the second end. Fluid is recovered by the oil skimmer at the first end (18).

In one embodiment, the vessel (10) may be used in a partial batch mode. The vessel may be partially filled with the desired wash fluid and the oil-contaminated sand deposited through the feed inlet. The wash jets (20) may then be activated to wash and agitate the sand as it is being fed into the vessel and to push the sand towards the second end of the vessel. It is preferable to limit the addition of wash fluid through the wash jets so that the level of the wash fluid does not rise above the level of the oil draw off (24). Once clean sand has accumulated at the second end, they may be removed in a wash fluid slurry. New feedstock and additional wash fluid may then be added and the agitation process continued.

The oil recovered from the oil draw off (24) may be treated in a hydrocyclone to assist in the removal of any entrained or emulsified wash fluid or water and solid fine material.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

What is claimed is:

1. A separation vessel comprising:
(a) an elongate vessel having a first end and a second end, a bottom portion, and a longitudinal axis passing through the first and second ends, the bottom portion defining a plurality of longitudinal channels;
(b) a plurality of internal weirs transversely disposed within the vessel and having a top edge and a bottom edge, wherein the bottom edge does not block the longitudinal channels;
(c) a plurality of jets disposed along each longitudinal channel and aimed substantially towards the second end of the vessel;
(d) a pump subsystem for pressurizing a wash fluid and directing the fluid through the jets into the vessel;
(d) a feedstock inlet associated with the first end of the vessel; and
(e) an oil skimmer which is substantially level with or higher than the height of the top edge of an internal weir, and
(f) a solids outlet.

2. The vessel of claim 1 wherein the oil skimmer is located at the first end of the vessel.

3. The vessel of claim 1 wherein the pump subsystem comprises an overhead pipe and a downpipe to deliver wash fluid to the plurality of jets.

4. The vessel of claim 3 wherein the solids outlet is located at the second end of the first vessel.

5. The vessel of claim 1 wherein the longitudinal channels are “V” shaped in traverse cross-section.

6. The vessel of claim 5 wherein there are four longitudinal channels.

7. The vessel of claim 1 comprising 2 or more traverse weirs.
